(19) United States
(12) Patent Application Publication
(10) Pub. No.: US 2007/0016457 A1
(43) Pub. Date: Jan. 18, 2007

(54) Prescriptive combining of methodology modules including organizational effectiveness plus information technology for success

(76) Inventors: Christopher Schreiber, West Chester, PA (US); Megan McCusker Moore, East Fallowfield Township, PA (US); Sandra Jenniges, White Bear Lake, MN (US)

Correspondence Address: MORGAN LEWIS & BOCKIUS LLP, 1111 PENNSYLVANIA AVENUE NW, WASHINGTON, DC, 20004, US

(21) Appl. No.: 11/181,752

(22) Filed: Jul. 15, 2005

(51) Int. Cl. G06F 17/50

(52) U.S. Cl. 705/7

(57) ABSTRACT

A method of seamlessly combining best practices in information technology delivery (ITIQ) with those of organizational effectiveness (OE) strategy to improve the overall success rate in delivering information technology projects to clients.

### TECHNICAL FIELD

The invention relates to business methods for assuring information technology delivery.

### BACKGROUND OF THE INVENTION

Information technology (“IT”) is changing at an ever-faster rate and businesses that do not implement the latest IT risk being left behind in the marketplace. Implementing new IT can be a very expensive and potentially disruptive event in any business.

Many companies have developed IT methodologies to communicate how projects will be implemented. For example, IBM has developed the Rational Unified Process (RAP), Microsoft has developed the Microsoft Operations Framework (MOF), and the government of the United Kingdom has developed the IT Infrastructure Library (ITIL). All of these methodologies promise to deliver successful engagements through the use of a technical process.

Vis.align, Inc. has identified seven main reasons IT projects fail. Those reasons (also known as “failure modes”) are:

Ineffective teaming

Unclear objectives/lack of metrics

Poor communications

Change adversity

Unclear or inflexible IT processes

Poorly set or mismatched expectations

Lack of end user impact

None of these reasons are related to technology itself, but rather how it is implemented and received in terms of the impact to the organization as a whole. What is lacking in the IT methodologies is an organizational effectiveness (OE) strategy.

OE is the field of study and practice which focuses on the culture, values, systems, and behavior of an organization. The goal is to increase organizational health and optimize people, through planned interventions in the organization's processes, teams, and operations. Some examples of industry published materials in OE strategy include: Karl Albrecht's model of Client Hierarchy of Needs; Stephen Covey's 7 Habits of Highly Effective People; and John Kotter's Change Model. There exists a need in the field to combine IT methodologies and OE strategies to ensure successful engagements in the IT field.

In accordance with the teachings of the present invention, there is defined a new method of seamlessly combining best practices in IT delivery (ITIQ) with those of OE to improve the overall success rate in delivering IT projects to clients.

It is believed that such a method would constitute a significant advancement in the art.

### OBJECTS AND SUMMARY OF THE INVENTION

It is therefore a principal object of the present invention to improve the overall success rate in delivering IT projects to clients by providing orchestration of best in class technology with proven OE methodologies.

This object is attained in accordance with one embodiment of the invention wherein there is provided a method for seamlessly combining best practices in ITIQ with those of OE to improve the overall success rate in delivering projects to clients. This method comprises four phases: Envision, Build, Deploy, and Manage.

Each phase comprises four modules. The modules of the Envision phase include Vision and Scope, Project Planning, Change Readiness, and Effective Teaming. A module is a subset of a phase and is made up of tools, procedures, examples, and guidelines to meet the requirements of that module/phase. Modules of the Build phase include Design, Develop, and Test; Project Management; Change Communication; and Problem Solving and Collaboration. The phases of the Deploy module include Rollout Management, User Acceptance, Change Orchestration, and Knowledge Share. The phases of the Manage module include IT Service Management (ITIL), Optimization Planning, Return on Investment (ROI) Review, and End User Care.

Each phase includes two IT modules and two OE modules. The IT modules are Change Readiness and Effective Teaming from the Envision phase; Change Communication, and Problem Solving and Collaboration from the Build phase; Change Orchestration and Knowledge Share from the Deploy module; and ROI Review and End User Care from the Manage module. The OE modules are Vision and Scope, and Project Planning from the Build phase; Design Development and Test, and Project Management from the Build phase; Rollout Management and User Acceptance from the Deploy phase; and IT Service Management (ITIL) and Optimization Planning from the Manage phase.

There are also high level topics managed over the phases. The high level topics include Change Management, Team Building, Solution Development, and Project Management. Change management is managed over Change Readiness (Envision), Change Communication (Build), Change Orchestration (Deploy), and ROI Review (Manage). Team Building is managed over Effective Teaming (Envision), Collaboration (Build), Knowledge Transfer (Deploy), and End User Care (Manage). Solution Development is managed over Vision and Scope (Envision); Design, Develop, and Test (Build); User Acceptance (Deploy); and Optimization (Manage). Project Management is managed over Project Planning (Envision), Project Management (Build), Rollout Management (Deploy), and Service Management (Manage).

Using these ITIQ and OE modules within and across phases results in lowering the risk of project failure by keeping the failure modes in check.

### BRIEF DESCRIPTION OF THE DRAWINGS

FIG. 1 shows a flowchart of a methodology according to the present invention;

FIG. 2 shows a more detailed flowchart illustrating individual modules that make up the methodology of FIG. 1; and

FIG. 3 shows the methodology depicted in FIG. 2 along with high level topics managed over the phases.

### DETAILED DESCRIPTION

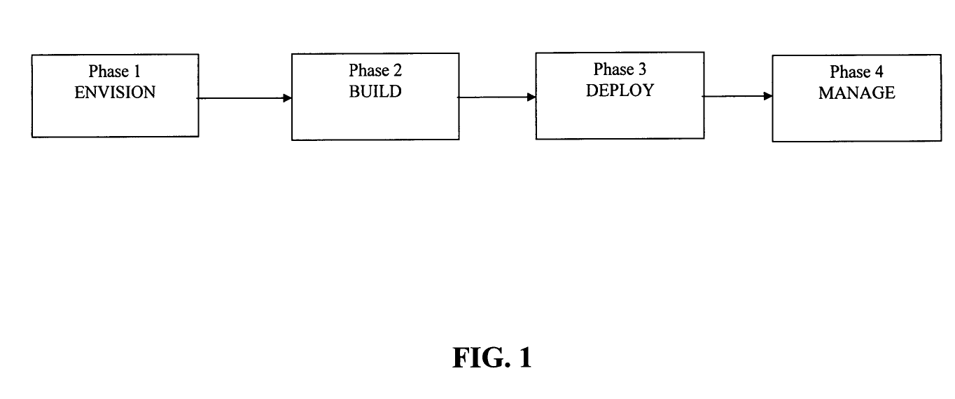

A preferred embodiment of the process flow for the methodology of the present invention is illustrated in FIG. 1. As shown the process comprises four phases: Envision (Phase 1), Build (Phase 2), Deploy (Phase 3), and Manage (Phase 4). For each phase, the successes are described to the clients. Averted project failure risks are also included. While the phases are generally completed sequentially, there may be overlap between the phases and a phase may be completed before a previous phase is completed.

In the Envision phase (Phase 1), a path is set for success. Success in the Envision phase (Phase 1) means agreed-upon expectations for project course and outcomes. The project failure risk to be averted is change adversity. Failing to consider the stakeholder awareness and readiness level—as well as the impact on business processes, culture, structure, and systems of the organization—decreases the likelihood that the solution will achieve a high level of user acceptance.

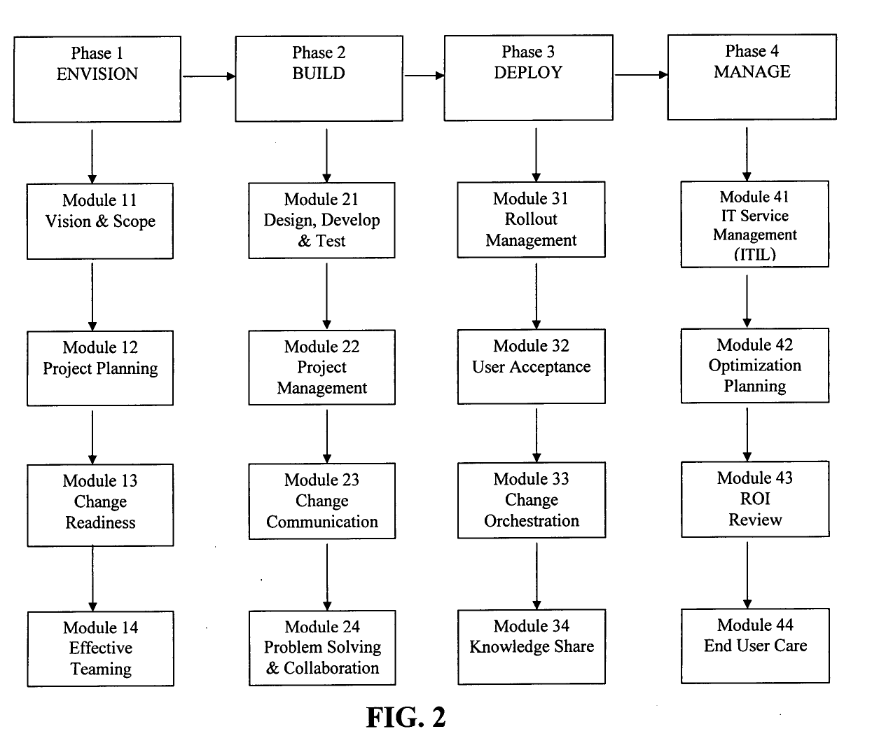

As shown in FIG. 2, a module (also known as a “core deliverable”) is a subset of a phase and is made up of tools, procedures, examples, and guidelines to meet the requirements of that module/phase. Modules within the Envision phase (Phase 1) are Vision and Scope (Module 11), Project Planning (Module 12), Change Readiness (Module 13), and Effective Teaming (Module 14). As with the phases, the modules are generally completed sequentially, but there may be overlap between the modules and a module may be completed before a previous module is completed.

The Vision and Scope module (Module 11) is an OE module and describes what the engagement is and why it is needed. Vision involves articulating and agreeing upon the strategy of the project and how it relates to the overall business objectives, while Scope sets the high level boundaries of the project. Clarifying Scope helps establish realistic expectations among stakeholders and provides a reference from which new features and changing requirements can be evaluated. The minimum requirements of the Vision and Scope module (Module 11) are a signed Engagement Authorization and any Change Control Forms, Key Success Factors, and requirements that fully describe the solution to be delivered.

The Project Planning module (Module 12) is an OE module and involves creating the plan to deliver the agreed upon vision and scope. Project Planning uses experience, skills, tools, and techniques to attain the correct balance of quality, cost, and time. The project plan is a document that identifies all project tasks and their dependencies, required resources and their availability, and project milestones/deliverables and their due dates. The minimum requirements of the Project Planning module (Module 12) are a project plan with tasks, required resources, start dates, dependencies, and durations listed; project budget (including whether the budget is time and material, fixed, or expenses), and project and product risks and mitigation tasks.

The Change Readiness module (Module 13) is an IT module and involves assessing the overall willingness of stakeholders to accept the proposed change in the environment and adopt new ways of working. This module can be considered the linchpin of the Envision phase because it determines the buy-in from the key stakeholders and the business acceptance to embrace the proposed capability. Identifying organizational risks and barriers helps the engagement team to adjust delivery and communications structures accordingly. The minimum requirement of the Change Readiness module (Module 13) is stakeholder buy-in.

The Effective Teaming module (Module 14) is an IT module and involves providing techniques to create an effective team to deliver the agreed upon Vision and Scope (Module 11). A team is effective when its members have the right skills, structure, chemistry, and leadership in place. In the Effective Teaming module (Module 14), stronger relationships are developed between colleagues and clients and a collaborative environment fostered. Expectations, roles, and boundaries are clarified and communication and escalation paths are laid down for all involved. The minimum requirements of the Effective Teaming module (Module 14) are roles and responsibilities for all team members, project mission statement, client profile, and internal and client kick-off meetings.

In the Build phase (Phase 2), a sustainable change effort is planned. Success within the Build phase (Phase 2) means collaboration, change, and risk management drive the development of the new capability. The project failure risk to be averted is ineffective teaming. Too often technology deployments fail to attend to the complexity that comes with numerous stakeholders. The reality of today is that vendors, employees, consultants, executives, and users all must collaborate successfully. Collaboration of this level requires a planned, thoughtful strategy and approach.

Modules within the Build phase (Phase 2) include Design, Develop, and Test (Module 21); Project Management (Module 22); Change Communication (Module 23); and Problem Solving and Collaboration (Module 24). The modules within the Build phase (Phase 2) are generally completed sequentially, but there may be overlap between the modules and a module may be completed before a previous module is completed.

The Design, Develop, and Test module (Module 21) is an IT module and provides the best practices used to convert the project requirements to a robust solution. Design refers to the functional (i.e., user) and technical (i.e., support) specifications, Develop involves the implementation of Design, and Test includes the unit (development) and functional (QA/staging) testing. The minimum requirements of the Design, Develop, and Test module (Module 21) are functional specifications, technical specifications, a test plan (with test cases), and a test report.

The Project Management module (Module 22) is an IT module involves providing the tools needed to manage the project to successful completion. Managing to desired outcomes requires proactive risk management so that actions can be taken to minimize the consequences of damaging events or situations. The minimum requirements of the Project Management module (Module 22) are updated project plans, status reports, status meetings, and client satisfaction surveys.

The Change Communication module (Module 23) is an OE module and entails the effective communication of impending changes throughout the client environment; i.e., with both stakeholder and end users. It enables the team to develop and communicate strategies to lead and manage the technology solution change. The tools in the Change Communication module (Module 23) ensure the user adoption strategy and messages to the end users are delivered clearly, consistently, and in a relevant and timely manner. These strategies are designed to reach multiple levels across the organization. The minimum requirements of the Change Communication module (Module 23) are a tactical communication plan for project rollout and change communications.

The Problem Solving and Collaboration module (Module 24) is an OE module and provides techniques to resolve technical and organizational issues in an innovative and collaborative manner. The Problem Solving module (Module 24) furthers solution development through a variety of problem solving techniques. These techniques help the team make the most effective decisions as they build out the technology solution. The minimum requirements of the Problem Solving and Collaboration module (Module 24) are design reviews, prototypes, and non-intrusive testing.

The Deploy phase (Phase 3) involves running a high performance initiative. Success within the Deploy phase (Phase 3) means quality management of the technology change including ongoing feedback mechanisms to ensure optimal customer care. The project risk to be averted is poor communications. Once a solution is introduced into an environment, the tendency is to push one-way communications to the user community. This practice severely hinders user adoption.

Modules within the Deploy phase (Phase 3) include Rollout Management (Module 31), User Acceptance (Module 32), Change Orchestration (Module 33), and Knowledge Share (Module 34). The modules of the Deploy phase (Phase 3) are generally completed sequentially, but there may be overlap between the modules and a module may be completed before a previous module is completed.

The Rollout Management module (Module 31) is an IT module and focuses on managing the release of the solution to the organization. New technical systems and capabilities in an environment often bring unforeseen risk, negatively impacting enterprise performance, integrity, and productivity. Applying project management best practices and OE tools to manage the rollout reduces risk and ensures maximum ROI. The minimum requirements for the Rollout Management module (Module 31) are updated project plans and a configuration management plan.

The User Acceptance module (Module 32) is an IT module and involves soliciting feedback from end users on the delivered solution. This module comprises validating user requirements as defined in the Vision and Scope phase (Phase 1), as well as generating a high level of user satisfaction. The minimum requirements for the User Acceptance module (Module 32) are a staging environment and a user acceptance test plan (with test cases).

The Change Orchestration module (Module 33) is an OE module and concerns continued effort in communicating and championing the technology change. This effort is conducted with stakeholders on multiple levels and through various channels. Coordination is required to ensure the messages are being received and that data is being collected to determine the effectiveness of the rollout. The minimum requirements of the Change Orchestration module (Module 33) are an updated communication plan; change communications; and change events such as training, meeting, and celebration.

The Knowledge Share module (Module 34) is an OE module and focuses on developing strategies for transferring knowledge to the client stakeholders. Methods for Knowledge Share range from documented processes to a training plan. Approaches to training incorporate adult learning principles to obtain the greatest impact. Minimum requirements for the Knowledge Share module (Module 34) include support documentation, end user documentation, and knowledge transfer events. Knowledge transfer events include a knowledge transfer plan and a knowledge transfer checklist.

The Manage phase (Phase 4) drives continuous value and return. Success within the Manage phase (Phase 4) means innovation practices drive unanticipated extensions of the solution and increases the return on business and human assets. The project risk to be averted is lack of end user impact. Most technical methodologies stop at deployment. Extending the value of a solution requires a focus on maximizing the positive impact on the user community.

Modules within the Manage phase (Phase 4) include IT Service Management (ITIL, Module 41), Optimization Planning (Module 42), ROI Review (Module 43), and End User Care (Module 44). The modules of the Manage phase (Phase 4) are generally completed sequentially, but there may be overlap between the modules and a module may be completed before a previous module is completed.

The IT Service Management module (Module 41) is an IT module and defines operational best practices for IT service delivery. The IT Infrastructure Library (ITIL®), is a series of documents that are used to aid in the implementation of a framework for IT Service Management (ITSM) and designed to manage IT as a competitive part of the organization. ITSM provides a process framework for improving service levels while lowering the cost of maintaining IT infrastructure. The minimum requirements of IT Service Management (Module 41) are ITIL policies and procedures, incident management, problem management, change management, release management, configuration management, and ITIL training.

The Optimization Planning module (Module 42) is an IT module and emphasizes the importance of continuous improvement in managing an IT investment. It includes tools that will benchmark and assess business performance and lead to effective decision-making beyond the current engagement. The minimum requirements of the Optimization Planning module (Module 42) are technical assessments, benchmarking reports, an optimization plan, and a system baseline.

The ROI Review module (Module 43) is an OE module and requires data collection against key metrics. It involves the project team working with the client to ensure the exit criteria have been delivered, performance objectives have been obtained, and the measurable business results have been realized. A case study documents the successes attained and the lessons learned. The minimum requirements for the ROI Review module are a case study highlighting the impact of the technology change on the business objectives and project Key Success Factors, and key performance metrics.

The End User Care module (Module 44) is an OE module and helps a company to stay centered on the client's specific needs while managing expectations to stay on target through transition to the technology change. The minimum requirements for the End User Care module (Module 44) are frequently asked questions (FAQs), end user communication scripts, an end user satisfaction survey, and survey results.

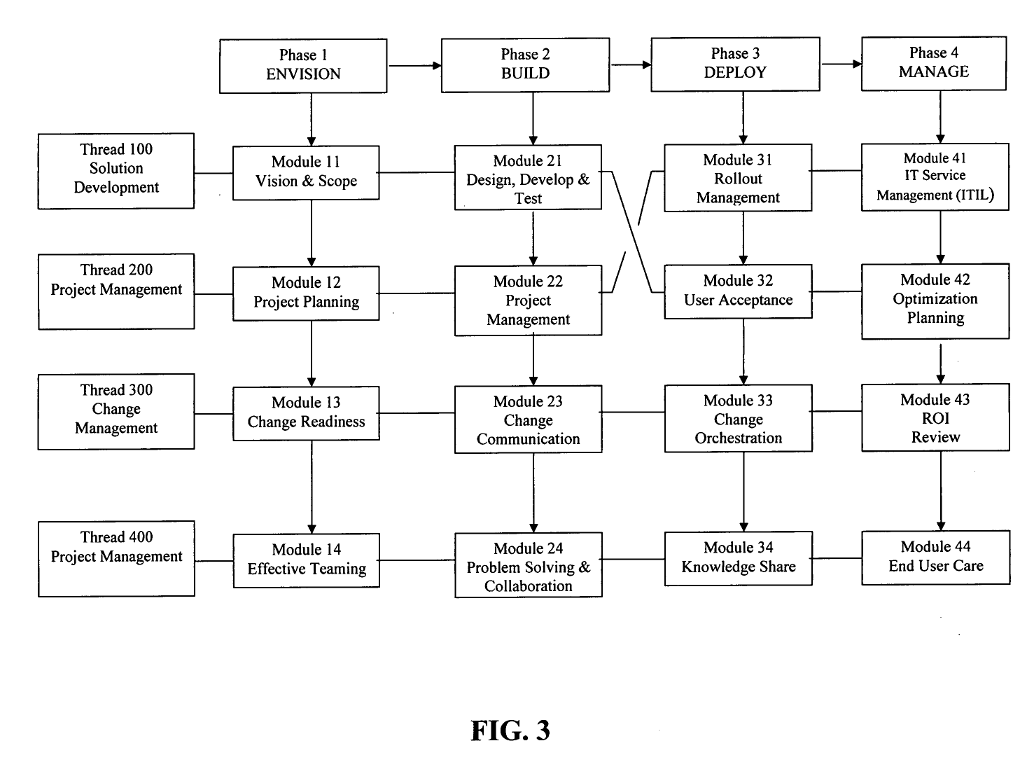

In addition to the modules being subsets of phases, high level topics (also known as “threads”) are managed over the phases as shown in FIG. 3. The Change Management thread (Thread 300) is managed over the Change Readiness module (Module 13) of the Envision phase (Phase 1), the Change Communication module (Module 23) of the Build phase (Phase 2), the Change Orchestration module (Module 23) of the Deploy phase (Phase 3), and the ROI Review module (Module 43) of the Manage phase (Phase 4).

The Team Building thread (Thread 400) is managed over the Effective Teaming module (Module 14) of the Envision phase (Phase 1), the Problem Solving and Collaboration module (Module 24) of the Build phase (Phase 2), the Knowledge Share module (Module 34) of the Deploy phase (Phase 3), and the End User Care module (Module 44) of the Manage phase (Phase 4).

The Solution Development thread (Thread 100) is managed over the Vision and Scope module (Module 11) of the Envision phase (Phase 1); the Design, Develop, and Test module (Module 21) of the Build phase (Phase 2); the User Acceptance module (Module 22) of the Deploy phase (Phase 3); and the Optimization Planning module (Module 42) of the Manage phase (Phase 4).

The Project Management thread (Thread 200) is managed over the Project Planning module (Module 12) of the Envision phase (Phase 1), the Project Management module (Module 22) of the Build phase (Phase 2), the Rollout Management module of the Deploy phase (Phase 3), and the IT Service Management (ITIL) module (Module 41) of the Manage phase (Phase 4).

What is claimed is:

1. A method for combining best practices in information technology and organizational effectiveness to improve delivery of an information technology project comprising:
setting a path for success by determining customer expectations for project course and success;
designing a sustainable change effort by change and risk management;
running a high performance initiative through quality management of technology change, including ongoing feedback mechanisms to ensure optimal customer care; and
driving continuous value and return through innovative practices which drive unanticipated extensions of the solution and increase the return on business and human assets.

2. The method as defined in claim 1, wherein in setting a path for success, the method further comprises:
articulating and determining a strategy of the project;
setting high level boundaries of the project;
creating a project plan to implement the strategy and high level boundaries of the project;
assessing the overall willingness of project stakeholders to accept the proposed changes and adopt new ways of working; and
providing techniques to create an effective team to implement the strategy and high level boundaries of the project.

3. The method as defined in claim 1, wherein in designing a sustainable change effort, the method further comprises:
providing best practices used to convert project requirements to a robust solution;
providing tools needed to manage the project to successful completion;
promoting effective communication of impending changes to both stakeholders and end users; and
providing techniques to resolve technical and organizational issues in an innovative and collaborative manner.

4. The method as defined in claim 1, wherein in running a high performance initiative, the method further comprises:
focusing on managing the release of a solution to the customer;
soliciting feedback from end users on the delivered project;
continuing effort in communicating and championing the technology change; and
developing strategies for transferring knowledge to client stakeholders.

5. The method as defined in claim 1, wherein in driving continuous value and return, the method further comprises:
defining operational best practices for information technology service delivery;
emphasizing the importance of continuous improvement in managing an information technology investment;
collecting data against key metrics; and
remaining centered on a customer's specific needs while managing expectations to stay on target through transition to the technology delivery.

6. A method for combining best practices in information technology and organizational effectiveness to improve delivery of an information technology project comprising:
setting a path for success by determining customer expectations for project course and success by carrying out the following:
articulating and determining a strategy of the project;
setting high level boundaries of the project;
creating a project plan to implement the strategy and high level boundaries of the project;
assessing overall willingness of project stakeholders to accept proposed changes and adopt new ways of working; and
providing techniques to create an effective team to implement the strategy and high level boundaries of the project;
designing a sustainable change effort by change, and risk management by carrying out the following:
providing best practices used to convert project requirements to a robust solution;
providing tools needed to manage the project to successful completion;
promoting effective communication of impending changes to both stakeholders and end users; and
providing techniques to resolve technical and organizational issues in an innovative and collaborative manner;
running a high performance initiative through quality management of technology change, including ongoing feedback mechanisms to ensure optimal customer care by carrying out the following:
focusing on managing release of a solution to the customer;
soliciting feedback from end users on the delivered project;
continuing effort in communicating and championing the technology change; and
developing strategies for transferring knowledge to the client stakeholders; and
driving continuous value and return through innovative practices which drive unanticipated extensions of the solution and increase the return on business and human assets by carrying out the following:
defining operational best practices for information technology service delivery;
emphasizing the importance of continuous improvement in managing an information technology investment;
collecting data against key metrics; and
remaining centered on the client's specific needs while managing expectations to stay on target through transition to the technology change.

7. The method of claim 6, further comprising
managing change while:
assessing overall willingness of project stakeholders to accept proposed changes and adopt new ways of working,
promoting effective communication of impending changes to both stakeholders and end users,
continuing effort in communicating and championing the technology change, and
collecting data against key metrics;
team building while:
providing techniques to create an effective team to implement the strategy and high level boundaries of the project,
providing techniques to resolve technical and organizational issues in an innovative and collaborative manner,
developing strategies for transferring knowledge to the client stakeholders, and
remaining centered on the client's specific needs while managing expectations to stay on target through transition to the technology change;
solution development while:
articulating and agreeing upon a strategy of the project,
setting high level boundaries of the project,
providing best practices used to convert project requirements to a robust solution,
soliciting feedback from end users on the delivered project, and
emphasizing the importance of continuous improvement in managing an information technology investment; and
project management while:
creating a project plan to implement the strategy and high level boundaries of the project,
providing tools needed to manage the project to successful completion,
focusing on managing release of a solution to the customer, and
defining operational best practices for information technology service delivery.

8. A method for combining best practices in information technology and organizational effectiveness to improve delivery of an information technology project comprising four phases, each phase comprising two information technology modules and two organizational effectiveness modules.

9. The method of claim 8, further comprising:
change management over at least one module of each phase;
team building management over at least one module of each phase;
solution development management over at least one module of each phase; and
project management over at least one module of each phase.
